(19) United States
(12) Patent Application Publication
(10) Pub. No.: US 2025/0240822 A1
(43) Pub. Date: Jul. 24, 2025

(54) METHOD AND DEVICE FOR TRANSMITTING OR RECEIVING SIGNAL IN WIRELESS COMMUNICATION SYSTEM

(71) Applicant: LG Electronics Inc., Seoul (KR)

(72) Inventors: Gyeongcheol LEE, Seoul (KR); Sunyoung LEE, Seoul (KR)

(21) Appl. No.: 18/698,602

(22) PCT Filed: Oct. 6, 2021
(86) PCT No.: PCT/KR2022/015041

§ 371 Date: Apr. 4, 2024

(30) Foreign Application Priority Data
Oct. 8, 2021 (KR) 10-2021-0134242

(51) Int. Cl. H04W 74/0833; H04B 17/318

(52) U.S. Cl. CPC H04W 74/0833; H04B 17/328

(57) ABSTRACT

A method and apparatus for performing operations in a wireless communication system disclosed herein may measure a RSRP of a downlink pathloss reference based on the preamble transmission counter being equal to or higher than a first threshold. And the second preamble is transmitted on a second random access occasion related to the MSG3 repetition based on the RSRP being lower than a second threshold.

### TECHNICAL FIELD

present disclosure relates to a method and apparatus for use in a wireless communication system.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of code division multiple access (CDMA) system, frequency division multiple access (FDMA) system, time division multiple access (TDMA) system, orthogonal frequency division multiple access (OFDMA) system, single carrier frequency division multiple access (SC-FDMA) system, and the like.

### DISCLOSURE OF INVENTION

### Technical Problem

The object of the present disclosure is to provide a method and apparatus for performing a random access procedure efficiently in a wireless communication system.

It will be appreciated by persons skilled in the art that the objects that could be achieved with the present disclosure are not limited to what has been particularly described hereinabove and the above and other objects that the present disclosure could achieve will be more clearly understood from the following detailed description.

### Solution to Problem

The present disclosure provides a method and apparatus for transmitting and receiving a signal in a wireless communication system.

In an aspect of the present disclosure, there is provided a method for performing operations of a User Equipment (UE) in a wireless communication system. The method may include: transmitting a first preamble on a first random access resource, wherein the first preamble is not associated with MSG3 repetition; increasing a preamble transmission counter by 1; based on the preamble transmission counter being equal to or higher than a first threshold, measuring a Reference Signal Received Power (RSRP) of a downlink pathloss reference; and based on the RSRP being lower than a second threshold, transmitting a second preamble on a second random access resource, wherein the second preamble is associated with MSG3 repetition.

In other aspects of the present disclosure, an apparatus, a processor and a storage medium for performing the signal monitoring method are provided.

The communication apparatus may include an autonomous driving vehicle communicable with at least a UE, a network, and another autonomous driving vehicle other than the communication apparatus.

The above-described aspects of the present disclosure are only some of the preferred embodiments of the present disclosure, and various embodiments reflecting the technical features of the present disclosure may be derived and understood from the following detailed description of the present disclosure by those skilled in the art.

### Advantageous Effects of Invention

According to an embodiment of the present disclosure, a communication apparatus may perform a random access procedure more efficiently in a different way from the prior art.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF DRAWINGS

FIG. 1 illustrates a radio frame structure.

FIG. 2 illustrates a resource grid during the duration of a slot.

FIG. 3 illustrates a self-contained slot structure.

FIGS. 4 and 5 show a random access process.

FIG. 6 is a diagram for explaining random access method according to an embodiment of the present disclosure.

FIGS. 7 to 10 show an example of apparatuses according to an embodiment of the present disclosure.

### MODE FOR THE INVENTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

For clarity of description, the present disclosure will be described in the context of a 3GPP communication system (e.g., LTE and NR), which should not be construed as limiting the spirit of the present disclosure. LTE refers to a technology beyond 3GPP TS 36.xxx Release 8. Specifically, the LTE technology beyond 3GPP TS 36.xxx Release 10 is called LTE-A, and the LTE technology beyond 3GPP TS 36.xxx Release 13 is called LTE-A pro. 3GPP NR is the technology beyond 3GPP TS 38.xxx Release 15. LTE/NR may be referred to as a 3GPP system. “xxx” specifies a technical specification number. LTE/NR may be generically referred to as a 3GPP system. For the background technology, terminologies, abbreviations, and so on as used herein, refer to technical specifications published before the present disclosure. For example, the following documents may be referred to.

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

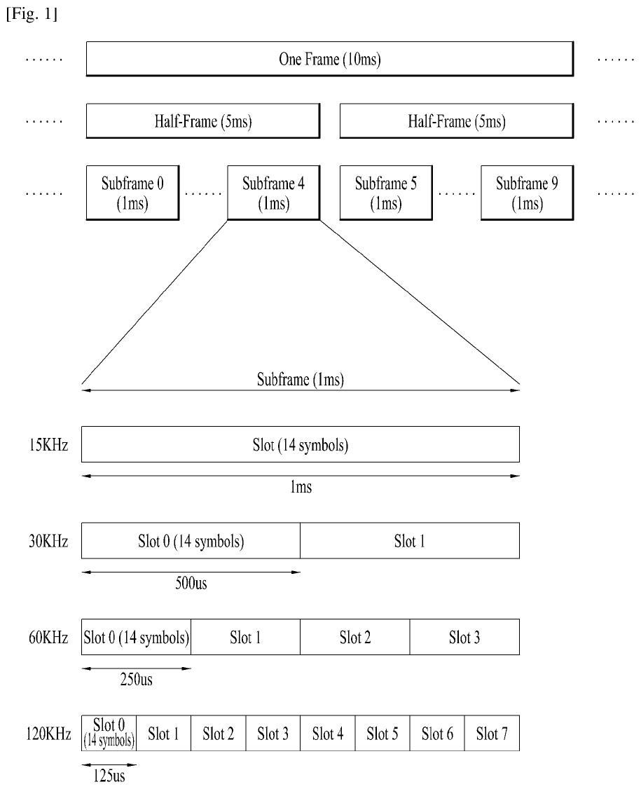

FIG. 1 illustrates a radio frame structure used for NR.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM (A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transformspread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame,u}ₛₗₒₜ | N^{subframe,u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: number of symbols in a slot
*N^{frame,u}ₛₗₒₜ: number of slots in a frame
*N^{subframe,u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame,u}ₛₗₒₜ | N^{subframe,u}ₛₗₒₜ |
|---|---|---|---|
| 60 KHz (u = 2) | 12 | 40 | 4 |

In the NR system, different OFDM (A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding frequency | Subcarrier |
|---|---|---|
| designation | range | Spacing |
| FR1 | 450 MHz-7125 MHz | 15, 30, 60 KHz |
| FR2 | 24250 MHz-52600 MHz | 60, 120, 240 KHz |

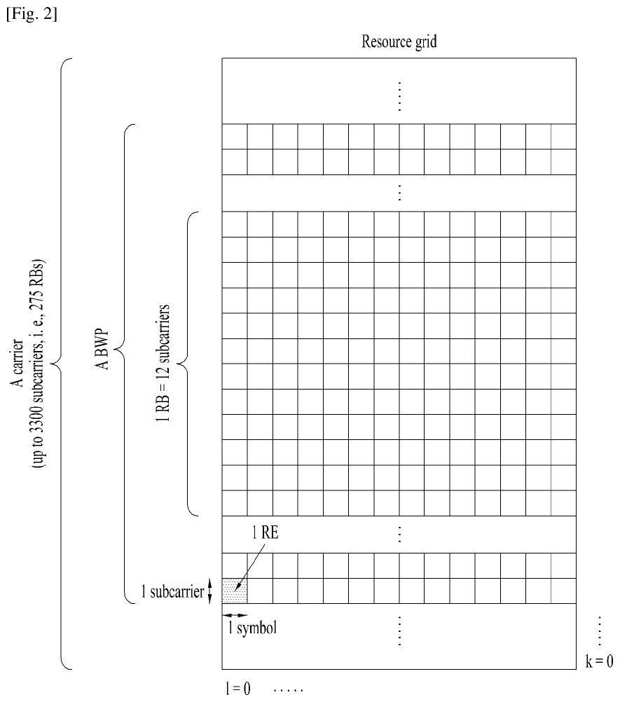

FIG. 2 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A plurality of RB interlaces (simply, interlaces) may be defined in the frequency domain. Interlace me {0, 1, . . . , M−1} may be composed of (common) RBs {m, M+m, 2M+m, 3M+m, . . . }. M denotes the number of interlaces. A bandwidth part (BWP) may be defined by a plurality of consecutive (physical) RBs ((P) RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

In a wireless communication system, a UE receives information from a BS in downlink (DL), and the UE transmits information to the BS in uplink (UL). The information exchanged between the BS and UE includes data and various control information, and various physical channels/signals are present depending on the type/usage of the information exchanged therebetween. A physical channel corresponds to a set of resource elements (REs) carrying information originating from higher layers. A physical signal corresponds to a set of REs used by physical layers but does not carry information originating from the higher layers. The higher layers include a medium access control (MAC) layer, a radio link control (RLC) layer, a packet data convergence protocol (PDCP) layer, a radio resource control (RRC) layer, and so on.

DL physical channels include a physical broadcast channel (PBCH), a physical downlink shared channel (PDSCH), and a physical downlink control channel (PDCCH). DL physical signals include a DL reference signal (RS), a primary synchronization signal (PSS), and a secondary synchronization signal (SSS). The DL RS includes a demodulation reference signal (DM-RS), a phase tracking reference signal (PT-RS), and a channel state information reference signal (CSI-RS). UL physical channel include a physical random access channel (PRACH), a physical uplink shared channel (PUSCH), and a physical uplink control channel (PUCCH). UL physical signals include a UL RS. The UL RS includes a DM-RS, a PT-RS, and a sounding reference signal (SRS).

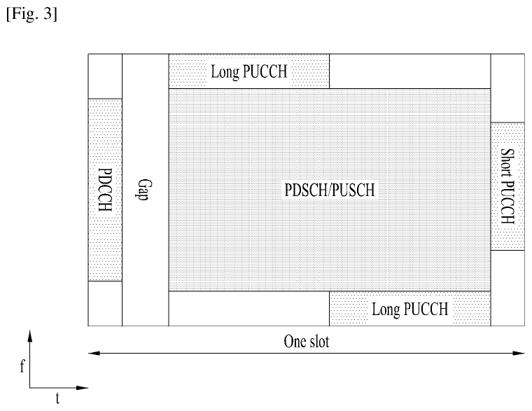

FIG. 3 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.

In the present disclosure, a base station (BS) may be, for example, a gNode B (gNB).

### 1. Random Access Procedure

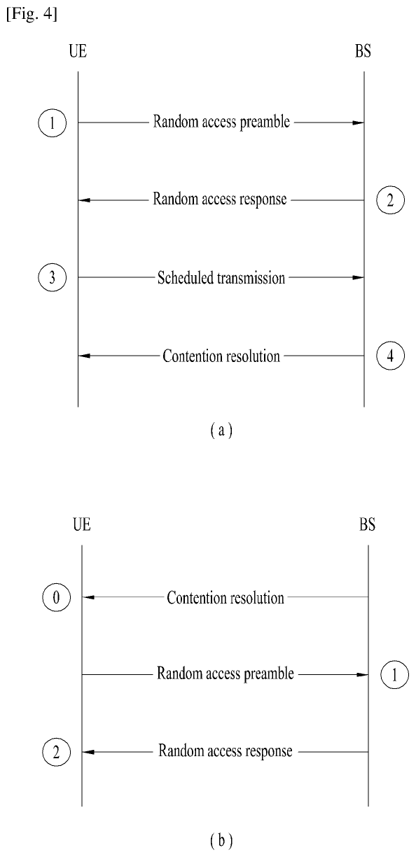

FIG. 4 illustrates random access procedures. FIG. 4(a) illustrates the contention-based random access procedure, and FIG. 4(b) illustrates the dedicated random access procedure.

Referring to FIG. 4(a), the contention-based random access procedure includes the following four steps. The messages transmitted in steps 1 to 4 may be referred to as message 1 (Msg1) to message 4 (Msg4), respectively.
Step 1: The UE transmits an RACH preamble on a PRACH.
Step 2: The UE receives a random access response (RAR) on a DL-SCH from the BS.
Step 3: The UE transmits a Layer 2 (L2)/Layer 3 (L3) message on a UL-SCH to the BS.
Step 4: The UE receives a contention resolution message on the DL-SCH from the BS.

The UE may receive random access information in system information from the BS.

When the UE needs random access, the UE transmits an RACH preamble to the BS as in step 1. The BS may identify each RACH preamble by a time/frequency resource (RACH occasion (RO)) in which the RACH preamble is transmitted, and a preamble index (PI).

Upon receipt of the RACH preamble from the UE, the BS transmits an RAR message to the UE as in step 2. To receive the RAR message, the UE monitors an L1/L2 PDCCH with a cyclic redundancy check (CRC) masked with a random access-RNTI (RA-RNTI), including scheduling information for the RAR message, within a preconfigured time window (e.g., ra-ResponseWindow). The PDCCH masked with the RA-RNTI may be transmitted only in a common search space. When receiving a scheduling signal masked with the RA-RNTI, the UE may receive an RAR message on a PDSCH indicated by the scheduling information. The UE then checks whether there is RAR information directed to the UE in the RAR message. The presence or absence of the RAR information directed to the UE may be determined by checking whether there is a random access preamble ID (RAPID) for the preamble transmitted by the UE. The index of the preamble transmitted by the UE may be identical to the RAPID. The RAR information includes the index of the corresponding RACH preamble, timing offset information (e.g., timing advance command (TAC)) for UL synchronization, UL scheduling information (e.g., UL grant) for Msg3 transmission, and UE temporary identification information (e.g., temporary-C-RNTI (TC-RNTI)).

Upon receipt of the RAR information, the UE transmits UL-SCH data (Msg3) on a PUSCH according to the UL scheduling information and the timing offset value, as in step 3. Msg3 may include the ID (or global ID) of the UE. Alternatively, Msg3 may include RRC connection request-related information (e.g., RRCSetupRequest message) for initial access. In addition, Msg3 may include a buffer status report (BSR) on the amount of data available for transmission at the UE.

After receiving the UL-SCH data, the BS transmits a contention resolution message (Msg4) to the UE as in step 4. When the UE receives the contention resolution message and succeeds in contention resolution, the TC-RNTI is changed to a C-RNTI. Msg4 may include the ID of the UE and/or RRC connection-related information (e.g., an RRCSetup message). When information transmitted in Msg3 does not match information received in Msg4, or when the UE has not received Msg4 for a predetermined time, the UE may retransmit Msg3, determining that the contention resolution has failed.

Referring to FIG. 4(b), the dedicated random access procedure includes the following three steps. Messages transmitted in steps 0 to 2 may be referred to as Msg0 to Msg2, respectively. The BS may trigger the dedicated random access procedure by a PDCCH serving the purpose of commanding RACH preamble transmission (hereinafter, referred to as a PDCCH order).
Step 0: The BS allocates an RACH preamble to the UE by dedicated signaling.
Step 1: The UE transmits the RACH preamble on a PRACH.
Step 2: The UE receives an RAR on a DL-SCH from the BS.

Steps 1 and 2 of the dedicated random access procedure may be the same as steps 1 and 2 of the contention-based random access procedure.

In NR, DCI format 1_0 is used to initiate a non-contention-based random access procedure by a PDCCH order. DCI format 1_0 is used to schedule a PDSCH in one DL cell. When the CRC of DCI format 1_0 is scrambled with a C-RNTI, and all bits *?* of a “Frequency domain resource assignment” field are 1s, DCI format 1_0 is used as a PDCCH order indicating a random access procedure. In this case, the fields of DCI format 1_0 are configured as follows.
RA preamble index: 6 bits
UL/supplementary UL (SUL) indicator: 1 bit. When the bits *?*?* of the RA preamble index are all non-zeroes and SUL is configured for the UE in the cell, the UL/SUL indicator indicates a UL carrier in which a PRACH is transmitted in the cell. Otherwise, it is reserved.
SSB (Synchronization Signal/Physical Broadcast Channel) index: 6 bits. When the bits *?*?* of the RA preamble index are all non-zeroes, the SSB indicator indicates an SSB used to determine an RACH occasion for PRACH transmission. Otherwise, it is reserved.
PRACH mask index: 4 bits. When the bits *?*?* of the RA preamble index are all non-zeroes, the PRACH mask index indicates an RACH occasion associated with the SSB indicated by the SSB index. Otherwise, it is reserved.
Reserved: 10 bits

When DCI format 1_0 does not correspond to a PDCCH order, DCI format 1_0 includes fields used to schedule a PDSCH (e.g., a time domain resource assignment, a modulation and coding scheme (MCS), an HARQ process number, a PDSCHto-HARQ_feedback timing indicator, and so on).

### 2-Step Random Access Procedure

In the prior art, random access is performed by a 4-step procedure as described above. In the legacy LTE system, an average of 15.5 ms is required for the 4-step random access procedure.

TABLE 4

| ▪ Component | Description | Time (ms) |
|---|---|---|
| ▪ 1 | Average delay due to RACH | 0.5 |
| | scheduling period (1 ms RACH cycle) | |
| ▪ 2 | RACH Preamble | 1 |
| ▪ 3-4 | Preamble detection and transmission | 3 |
| | of RA response (Time between the end | |
| | RACH transmission and UE's reception | |
| | of scheduling grant and timing | |
| | adjustment) | |
| ▪ 5 | UE Processing Delay (decoding of | 5 |
| | scheduling grant, | |
| | timing alignment and C- | |
| | RNTI assignment + L1 encoding of | |
| | RRC Connection Request) | |
| ▪ 6 | Transmission of RRC and NAS Request | 1 |
| ▪ 7 | Processing delay in eNB (L2 and RRC) | 4 |
| ▪ 8 | Transmission of RRC Connection | 1 |
| | Set-up (and UL grant) | |

The NR system may require lower latency than conventional systems. When random access occurs in a U-band, the random access may be terminated, that is, contention may be resolved only if the UE and BS sequentially succeed in LBT in all steps of the 4-step random access procedure. If the LBT fails even in one step of the 4-step random access procedure, resource efficiency may decrease, and latency may increase. If the LBT fails in a scheduling/transmission process associated with Msg2 or Msg3, the resource efficiency may significantly decrease, and the latency may significantly increase. For random access in an L-band, low latency may be required in various scenarios of the NR system. Therefore, a 2-step random access procedure may be performed in the L-band as well.

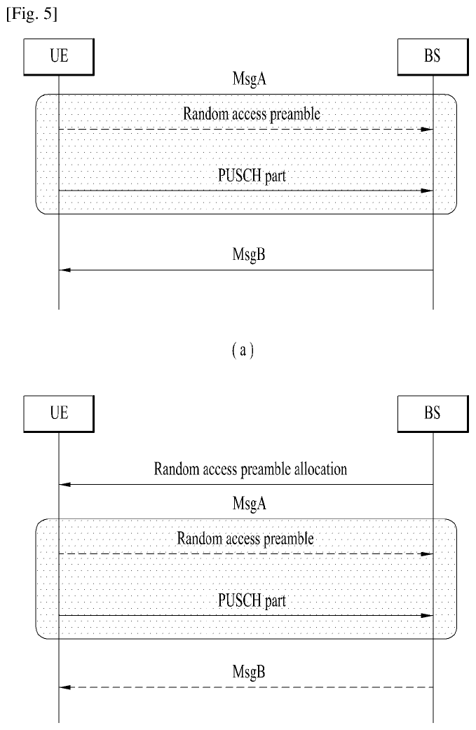

As illustrated in FIG. 5(a), the 2-step random access procedure may include two steps: transmission of a UL signal (referred to as MsgA) from the UE to the BS and transmission of a DL signal (referred to as MsgB) from the BS to the UE.

The following description focuses on the initial access procedure, but the proposed methods may be equally applied to the random access procedure after the UE and BS establish an RRC connection. Further, a random access preamble and a PUSCH part may be transmitted together in a non-contention random access procedure as shown in FIG. 5(b).

While not shown, the BS may transmit a PDCCH for scheduling Msg. B to the UE, which may be referred to as a Msg. B PDCCH.

2. Handling RACH Failure with Msg3 Repetition

The above-described contents (NR frame structure, RACH procedure, etc.) may be applied in combination with methods proposed in the present specification to be described below, or may be supplemented to clarify the technical features of the methods proposed in the present specification.

Methods related to the RACH procedure in the NR system or LTE system described above, and needless to say, the technological spirit proposed in the present specification may be modified or replaced according to the term, expression, structure, etc. defined in each system to be implemented in the corresponding system.

In LTE, Msg3 repetition was studied and introduced to extend RACH coverage. When a UE initiates a RACH procedure, the UE measures RSRP of DL (downlink) reference and selects a coverage enhanced (CE) level based on the measured RSRP, then transmits a preamble on the selected CE level. If RACH attempt on the selected CE level fails as many as a threshold for CE level change, the UE moves on to the next CE level and tries a new RACH attempt. If the total number of RACH attempt failure is equal to the maximum RA preamble transmission configured for determining RACH failure, the UE considers RACH is failed and indicates a RACH problem to upper layers.

Compared to LTE, NR is designed to operate at much higher frequencies such as 3.5 GHz in FR1 or 28 GHz, 39 GHz in FR2. Due to the higher frequencies, it is inevitable that the wireless channel will be subject to higher path-loss making it more challenging to maintain an adequate quality of service that is at least equal to that of legacy RATs. For this reason, Msg3 repetition for NR is also considered to extend RACH coverage as in LTE, but the detail procedure is different from LTE. The UE measures RSRP of DL reference while initializing RACH parameters. For example, if the measured RSRP is less than the threshold, the UE starts a RACH procedure with Msg3 repetition. If the measured RSRP is higher than the threshold, the UE starts a RACH procedure without Msg3 repetition. After starting a RACH procedure, the UE keeps using one RACH resources, i.e., if RACH procedure without Msg3 repetition is started, same RACH resource is used until the UE declares a RACH problem which can be determined based on the counted RACH attempt failure. When the total failed RACH attempt is equal to the configured maximum number of RA preamble transmission, the UE considers RACH procedure is finished with the RACH problem and indicates this problem to upper layers.

However, considering UE mobility, the measured RSRP of DL reference can be changed dynamically. This means that even though the UE starts the RACH without Msg3 repetition due to the measured RSRP higher than the threshold, when the UE transmits a preamble for RA without Msg3 repetition, the actual measured RSRP at this time point can be less than the threshold that actually needs Msg3 repetition. But the UE should keep using the RACH resource without Msg3 repetition during this RACH procedure and finally this would cause a RACH problem which will be indicated to upper layer. If the UE is in RRC_CONNECTED state, the UE may release all configuration and perform RRC re-establishment unnecessarily. Thus, from service continuity and radio resource efficiency perspective, this problem should be resolved to increase RACH and overall service performance.

To increase service continuity and RACH performance, it is invented that when a UE fails a random access response (RAR) reception or contention resolution after transmitting a random access preamble (RAP), the UE increments the RAP transmission counter by 1. When the RAP transmission counter is equal to the configured maximum number of Random Access Preamble transmission (preambleTransMax), the UE measures RSRP of DL reference. If the measured RSRP is less than a threshold and the transmitted preamble is for normal RA, i.e., non-Msg3 repetition, the UE starts a new RACH procedure for Msg3 repetition without indicating a RACH problem to upper layers. If the measured RSRP is higher than a threshold, the UE indicates the RACH problem to upper layers.

A UE is configured with RACH configuration at least including at least two sets of RACH resources, a threshold, and the maximum number of Random Access Preamble transmission (preambleTransMax). One RACH resource set among at least two sets of RACH resources is for a RACH procedure without Msg3 repetition and another RACH resource set among at least two sets of RACH resources is for a RACH procedure with Msg3 repetition. Each RACH resource includes at least a set of preamble and RACH occasions. RACH occasions may be shared by both RACH with Msg3 repetition and RACH without Msg3 repetition. If the RACH occasions are shared, the preamble set for RACH with Msg3 repetition may not be overlapped with the preamble set for RACH without Msg3 repetition. If the RACH occasions are not shared between RACH with Msg3 repetition and RACH without Msg3 repetition, the preamble set for RACH with Msg3 repetition may be overlapped with the preamble set for RACH without Msg3 repetition. The threshold is used to determine whether to select the RACH resource set for Msg3 repetition or not. The preambleTransMax is used to determine whether there is a RACH problem or not, i.e., if the RACH is failed as many as the preambleTransMax, the UE considers there is a RACH problem and indicates the RACH problem to upper layers. The RACH configuration also includes necessary parameters for RAR reception and contention resolution.

When the UE initiates a RACH procedure, the UE initializes RACH parameters including at least followings:
PREAMBLE_TRANSMISSION_COUNTER: a random access preamble transmission counter;
rsrp-ThresholdSSB-Msg3Rep: a RSRP threshold for Msg3 repetition, this parameter can also be expressed as rsrp-ThresholdMsg3;
ra-Response Window: the time window to monitor RA response(s);
ra-ContentionResolutionTimer: the Contention Resolution Timer;
preambleTransMax: the maximum number of Random Access Preamble transmission;
The set of Random Access Preambles and/or PRACH occasions for Msg3 repetition;
The set of Random Access Preambles and/or PRACH occasions for non-Msg3 repetition, non-Msg3 repetition means Msg3 is transmitted without repetition, i.e., RACH resource without Msg3 repetition;
Initial transmission power and ramping step.

The UE measures RSRP of DL reference during initializing RACH parameters or after initializing RACH parameters. The DL reference can be SSB, CSI-RS, or other physical signal/channel:

Step 0-1. if the measured RSRP is equal to or higher than the rsrpThresholdSSB-Msg3Rep, the UE selects the RACH resource set for non-Msg3 repetition;

Step 0-2. else if the measured RSRP is less than the rsrp-ThresholdSSB-Msg3Rep, the UE selects the RACH resource set for Msg3 repetition.

After selecting the RACH resource set, the UE selects a preamble and RACH occasion from the selected RACH resource set and transmits the selected preamble on the selected RACH occasion and then starts the ra-Response Window.

The UE monitors the PDCCH for Random Access Response(s) identified by the RA-RNTI while the ra-ResponseWindow is running. The RA-RNTI is calculated by the selected RACH occasion which is used for transmission of the selected preamble as specified in TS38.321. If the UE does not receives RAR including the preamble identifier which is associated with the transmitted preamble until the ra-ResponseWindow expires, the UE considers the Random Access Response (RAR) reception is not successfully completed. If the Random Access Response (RAR) reception is not successfully completed, the UE increments PREAMBLE_TRANSMISSION_COUNTER by 1:
Step 1-1. if the PREAMBLE_TRANSMISSION_COUNTER is less than the preambleTransMax, the UE starts another RACH attempt using the selected RACH resource after backoff time which is randomly determined according to a uniform distribution between 0 and the value given by the network;
Step 1-2. else if the PREAMBLE_TRANSMISSION_COUNTER is equal to or higher than the preambleTransMax, the UE measures RSRP of DL reference:
Step 1-2-1. if the measured RSRP is less than the rsrp-ThresholdSSB-Msg3Rep and/or the selected RACH resource set is for non-Msg3 repetition, the UE selects (and switch to) the RACH resource set for Msg3 repetition and starts a new RACH attempt or RACH procedure using the selected RACH resource set for Msg3 repetition. When the new RACH attempt/procedure using the selected RACH resource set for Msg3 repetition, RACH parameters and related counters/timers may be initialized or set to a specific value which is given by the network;
Step 1-2-2. else if the measured RSRP is higher than the rsrpThresholdSSB-Msg3Rep or the selected RACH resource set is for Msg3 repetition, the UE indicates RACH problem to upper layers, e.g., RRC, and finish the RACH procedure.

If the RAR reception is successfully completed, the UE generates an Msg3 which includes an identifier for contention resolution and transmits the Msg3 using the UL grant which is given by the RAR. If the RACH resource for Msg3 repetition is used, the number of repetition may be given in the RAR and the UE transmits the Msg3 repeatedly up to the given number of repetition. Once Msg3 is transmitted, the UE also starts the ra-ContentionResolutionTimer and monitor the PDCCH while the ra-ContentionResolutionTimer is running.

If the contention resolution is successfully completed after receiving an Msg4, the UE completes RACH procedure. If the UE receive the Msg4, but this Msg4 has the identifier which is different from the identifier transmitted in the Msg3, the UE considers contention resolution is not successfully completed. If the UE does not receive the Msg4 until ra-ContentionResolutionTimer expires, the UE considers contention resolution is not successfully completed. When contention resolution is not successfully completed, the UE may discard a temporary identifier which is used for the Msg3 transmission and flush the HARQ buffer used for transmission of the MAC PDU in the Msg3 buffer;

If the contention resolution is not successfully completed, the UE increments PREAMBLE_TRANSMISSION_COUNTER by 1:

Step 3-1. if the PREAMBLE_TRANSMISSION_COUNTER is less than the preambleTransMax, the UE starts another RACH attempt using the selected RACH resource after backoff time which is randomly determined according to a uniform distribution between 0 and the value given by the network;

Step 3-2. else if the PREAMBLE_TRANSMISSION_COUNTER is equal to or higher than the preambleTransMax, the UE measures RSRP of DL reference:

Step 3-2-1. if the measured RSRP is less than the rsrp-ThresholdSSB-Msg3Rep and/or the selected RACH resource set is for non-Msg3 repetition, the UE selects (and switch to) the RACH resource set for Msg3 repetition and starts a new RACH attempt or RACH procedure using the selected RACH resource set for Msg3 repetition. When the new RACH attempt/procedure using the selected RACH resource set for Msg3 repetition, RACH parameters and related counters/timers may be initialized or set to a specific value which is given by the network;

Step 3-2-2. else if the measured RSRP is higher than the rsrpThresholdSSB-Msg3Rep or the selected RACH resource set is for Msg3 repetition, the UE indicates RACH problem to upper layers, e.g., RRC, and finish the RACH procedure.

When the network receives the preamble, the network transmits RAR at least including the preamble identifier which is associated with the transmitted preamble by the UE and/or UL grants for Msg3 transmission and/or backoff value and/or the temporary identifier for Msg3 transmission and/or timing advance command. If the preamble is selected for RACH with Msg3 repetition, the network may include the number of repetition for Msg3 in the RAR.

When the network receives the Msg3, the network transmits the Msg4 including the identifier which was transmitted in the Msg3 for contention resolution. The UE uses the same RACH resource set during one RACH procedure. One RACH procedure may comprise between the beginning of the RACH parameter initialization and the point of the last RACH attempt failure. The last RACH attempt failure means that the number of preamble transmission of this RACH procedure is equal to the preamble TransMax.

According to the present disclosure, the UE can avoid unnecessary RACH problem and RRC re-establishment which causes lots of service discontinuity and radio resource waste. The Msg3 repetition can be also used efficiently to extend coverage.

Since examples of the above-described proposal method may also be included in one of implementation methods of the various embodiments, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal). The higher layer may include, for example, one or more of functional layers such as MAC, RLC, PDCP, RRC, or SDAP.

Methods, embodiments, or descriptions for implementing the method proposed in the present specification may be separately applied or one or more methods (embodiments, or descriptions) may be combined and applied.

### Implementation Examples

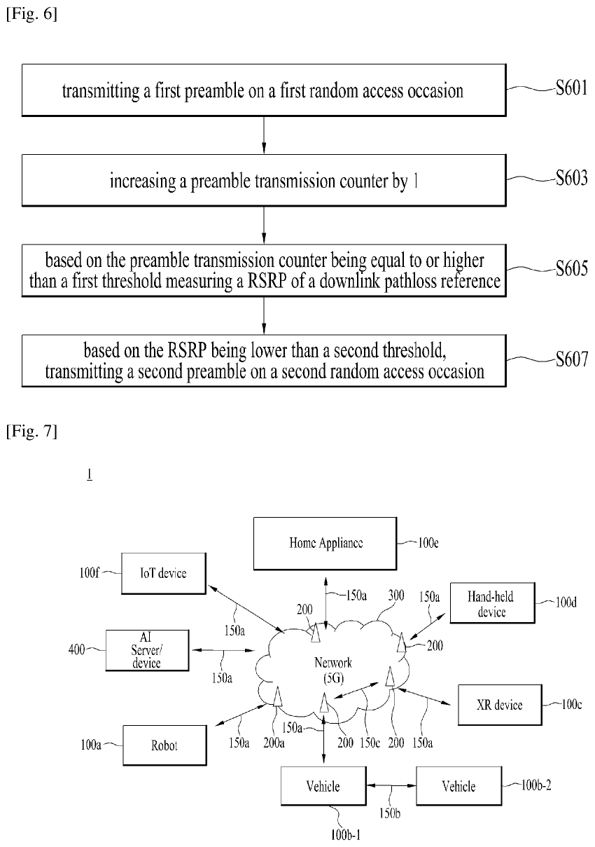

FIG. 6 is a flowchart of a signal transmission/reception method according to embodiments of the present disclosure.

Referring to FIG. 6, an embodiment performed by the UE may include: transmitting a first preamble on a first random access occasion (S601); increasing a preamble transmission counter by 1 (S603); based on the preamble transmission counter being equal to or higher than a first threshold, measuring a RSRP of a downlink pathloss reference (S605); based on the RSRP being lower than a second threshold, transmitting a second preamble on a second random access occasion (S607).

The random access procedure may be performed based on one or more of the operations described in Section 2.

The preamble transmission counter is the PREAMBLE_TRANSMISSION_COUNTER described in Section 2. Referring to Section 2, the preamble transmission counter may be increased when the UE considers the Random Access Response (RAR) reception is not successfully completed or when the UE considers contention resolution is not successfully completed.

In addition, the UE considers the Random Access Response (RAR) reception is not successfully completed if the UE does not receive a RAR including the preamble identifier which is associated with the transmitted preamble until the ra-Response Window expires. And the UE considers contention resolution is not successfully completed if the UE does not receive the Msg4 which include the identifier which is same with the identifier transmitted in the Msg3 or if the UE does not receives PDCCH transmission addressed to the identifier transmitted in the Msg3 until ra-ContentionResolutionTimer expires.

In other words, there are two cases for increasing the preamble transmission counter by 1 after the UE transmits the first preamble on the first random access occasion.

In a first case, an embodiment performed by the UE may include: monitoring a PDCCH for a RAR containing an identifier that matches the first preamble while a first timer is running. Wherein the preamble transmission counter is increased based on the RAR containing the identifier that matches the first preamble having not been received until the first timer expires. And the first timer is the ra-ResponseWindow described in Section 2.

In second case, an embodiment performed by the UE may include: receiving a RAR containing an identifier that matches the first preamble while the first timer is running; transmitting a MSG3 based on the RAR; and monitoring a PDCCH for a contention resolution message including an identifier for the MSG3 while a second timer is running. Wherein the preamble transmission counter is increased based on the contention resolution message being not received until the second timer expires or the preamble transmission counter is increased based on the PDCCH addressed to the identifier for the MSG3 until the second timer expires. And the second timer is the ra-ContentionResolutionTimer described in Section 2.

In the above two cases, the RSRP of a downlink pathloss reference is measured by the UE if the preamble transmission counter is equal to or higher than the first threshold. The first threshold may be the preambleTransMax described in Section 2 or preambleTransMax+1. The downlink pathloss reference is DL reference described in section 2. Hence, the downlink pathloss reference can be a SSB, a CSI-RS and/or other physical signal/channel.

If the preamble transmission counter is less than (or lower than) the first threshold, the first preamble and the first random access occasion is reselected the first random access resource set for non-MSG3 repetition and the reselected first preamble is transmitted by the UE on the reselected first random occasion after random backoff time, and the RSRP of the downlink pathloss reference is not measured.

Additionally, the RSRP of the downlink pathloss reference is measured when the transmitted first preamble is not associated with MSG3 repetition. Therefore, the first preamble and the first random access occasion are associated with the first random access resource set for non-MSG3 repetition. The first random access resource set can be expressed as a set of random access resources without MSG3 repetition indication.

As described in FIG. 6, the second preamble is transmitted by the UE on the second random access occasion if the RSRP is lower than the second threshold. And the second preamble and the second random access occasion are selected in the resource set for MSG3 repetition. Thus, the second preamble and the second random access occasion are associated with the MSG3 repetition. The second resource set can be expressed as a set of random access resources with MSG3 repetition indication. The second threshold may be the rsrp-ThresholdMsg3 described in Section 2.

If the RSRP is equal to or higher than the second threshold, the random access problem is indicated by the UE to the RRC layer and the second preamble is not transmitted. Although it is merely stated as ‘if the measured RSRP is higher than the rsrp-ThresholdSSB-Msg3Rep or the selected RACH resource set is for Msg3 repetition’ in Section 2, the preamble associated with the MSG3 repetition is not transmitted if the measured RSRP is equal to or higher than the second threshold in Step 0-1 and Step 0-2. Consequently, the operation of indicating the random access problem can performed if the RSRP is equal to or higher than the second threshold.

Before the second transmission preamble is transmitted, the UE may initialize RACH parameters including the preamble transmission counter. In the legacy wireless communication system, the preamble transmission counter is set to 1 during initializing RACH parameters.

The rsrp-ThresholdMsg3 is commonly used when the RACH parameters are initialized and the preamble transmission counter is equal to or higher than the first threshold. In other words, in the first step of FIG. 6, the first preamble may be transmitted based on a second RSRP of the downlink pathloss reference being equal to or higher than the second threshold. The second RSRP is measured by the UE during initializing RACH parameters or after initializing RACH parameters. That is, the second RSRP is measured before transmitting the first preamble.

Since the second preamble is transmitted based on the RSRP being less than the second threshold, it can be known that the dynamic change of the RSRP of the downlink pathloss reference occurring between the transmission of the first preamble and the transmission of the second preamble is reflected through the present disclosure.

The operations described with reference to FIG. 6 may be additionally performed in combination with at least one of the operations described with reference to FIGS. 1 to 5 and/or the operations described in Sections 1 and 2.

Example of Communication System to which the Present Disclosure is Applied

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

FIG. 7 illustrates a communication system 1 applied to the present disclosure.

Referring to FIG. 7, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

Example of Wireless Device to which the Present Disclosure is Applied

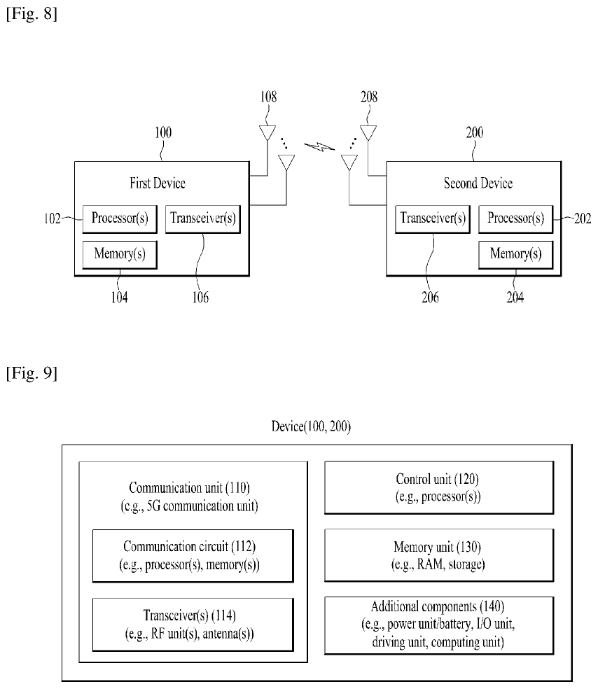

FIG. 8 illustrates wireless devices applicable to the present disclosure.

Referring to FIG. 8, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 7.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

Example of Use of Wireless Device to which the Present Disclosure is Applied

FIG. 9 illustrates another example of a wireless device applied to the present disclosure. The wireless device may be implemented in various forms according to a use case/service (refer to FIG. 7).

Referring to FIG. 9, wireless devices 100 and 200 may correspond to the wireless devices 100 and 200 of FIG. 8 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 8. For example, the transceiver(s) 114 may include the one or more transceivers 106 and 206 and/or the one or more antennas 108 and 208 of FIG. 8. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 7), the vehicles (100b-1 and 100b-2 of FIG. 7), the XR device (100c of FIG. 7), the hand-held device (100d of FIG. 7), the home appliance (100e of FIG. 7), the IoT device (100f of FIG. 7), a digital broadcasting terminal, a hologram device, a public safety device, an MTC device, a medical device, a FinTech device (or a finance device), a security device, a climate/environment device, the AI server/device (400 of FIG. 7), the BSs (200 of FIG. 7), a network node, or the like. The wireless device may be mobile or fixed according to a use case/service.

In FIG. 9, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

Example of Vehicle or Autonomous Driving Vehicle to which the Present Disclosure is Applied

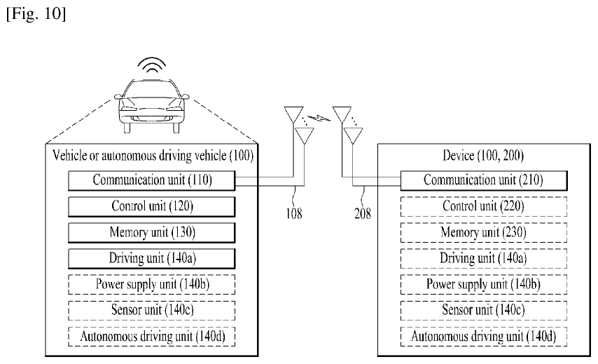

FIG. 10 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 10, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 9, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

As described above, the present disclosure is applicable to various wireless communication systems.

1. A method for performing operations of a User Equipment (UE) in a wireless communication system, the method comprising:
transmitting a first preamble on a first random access occasion, wherein the first preamble and the first random access occasion are not associated with MSG3 repetition;
increasing a preamble transmission counter by 1;
based on the preamble transmission counter being equal to or higher than a first threshold, measuring a Reference Signal Received Power (RSRP) of a downlink pathloss reference; and
based on the RSRP being lower than a second threshold, transmitting a second preamble on a second random access occasion, wherein the second preamble or the second random access occasion is associated with the MSG3 repetition.

2. The method of claim 1, further comprising:
based on the RSRP being equal to or higher than the second threshold, indicating a random access problem to a Radio Resource Control (RRC) layer.

3. The method of claim 1, wherein, based on the second preamble being transmitted, the preamble transmission counter is set to 1.

4. The method of claim 1, further comprising:
monitoring a Physical Downlink Control Channel (PDCCH) for a Random Access Response (RAR) containing an identifier that matches the first preamble while a first timer is running,
wherein the preamble transmission counter is increased based on the RAR containing the identifier that matches the first preamble having not been received until the first timer expires.

5. The method of claim 1, further comprising:
receiving a Random Access Response (RAR) containing an identifier that matches the first preamble while a first timer is running;
transmitting a MSG3 based on the RAR; and
monitoring a Physical Downlink Control Channel (PDCCH) for a contention resolution message including an identifier for the MSG3 while a second timer is running,
wherein the preamble transmission counter is increased based on the contention resolution message being not received until the second timer expires or the PDCCH addressed to the identifier for the MSG3 being not received until the second timer expires.

6. The method of claim 1, wherein the downlink pathloss reference is a Synchronization Signal Block (SSB) or Channel State Information-Reference Signal (CSI-RS).

7. The method of claim 1, wherein the first preamble and the first random access occasion are selected from a first random access resource set for non-MSG3 repetition, and the second preamble and the second random access occasion are selected from a second random access resource set for the MSG3 repetition.

8. The method of claim 7, further comprising:
based on the preamble transmission counter being less than the first threshold, reselecting the first preamble and the first random access occasion from the first random access resource set for the non-MSG3 repetition and transmitting the reselected first preamble on the reselected first random access occasion after random backoff time.

9. The method of claim 7, wherein the first preamble is transmitted on the first random access occasion based on a RSRP of a downlink pathloss reference, measured before transmitting the first preamble, being equal to or higher than the second threshold.

10. A user equipment (UE) in a wireless communication system, the UE comprising:
at least one transceiver;
at least one processor; and
at least one computer memory operably connectable to the at least one processor and storing instructions that, when executed, cause the at least one processor to perform operations comprising:
transmitting a first preamble on a first random access occasion, wherein the first preamble and the first random access occasion are not associated with MSG3 repetition;
increasing a preamble transmission counter by 1;
based on the preamble transmission counter being equal to or higher than a first threshold, measuring a Reference Signal Received Power (RSRP) of a downlink pathloss reference; and
based on the RSRP being lower than a second threshold, transmitting a second preamble on a second random access occasion, wherein the second preamble or the second random access occasion is associated with the MSG3 repetition.

11-12. (canceled)
